(19) United States
(12) Patent Application Publication
(10) Pub. No.: US 2004/0179606 A1
(43) Pub. Date: Sep. 16, 2004

(54) Method for transcoding fine-granular-scalability enhancement layer of video to minimized spatial variations

(76) Inventors: Jian Zhou, Seattle, WA (US); Huai-Rong Shao, Cambridge, MA (US); Chia Shen, Lexington, MA (US)

Correspondence Address: Patent Department, Mitsubishi Electric Research Laboratories, Inc., 201 Broadway, Cambridge, MA, 02139, US

(21) Appl. No.: 10/371,087

(22) Filed: Feb. 21, 2003

(51) Int. Cl. H04N 7/12

(52) U.S. Cl. 375/240.25

(57) ABSTRACT

A method for transcoding a video. First, a video is encoded into a base layer and one or multiple enhancement layers. Next, the last enhancement layer is partially decoded if an available bit-rate will truncate the last enhancement layer to be transmitted. A number of bits in the partially decoded last transmitted enhancement layer is reduced to match the available bit-rate, and the reduced bit-rate enhancement layer is then reencoded before transmission.

### FIELD OF THE INVENTION

The invention relates generally to streaming compressed videos, and more particularly to transcoding bit-planes of fine-granular-scalability enhancement layers of a streaming video.

### BACKGROUND OF THE INVENTION

For applications that stream a compressed video over a network, such as the Internet, one important concern is to deliver the video stream to a receiver with different resources, access paths, and processors. Therefore, content of the video is dynamically adapted to heterogeneous environments found in such networks.

Fine-granular-scalability (FGS) has been developed for the MPEG-4 standard to adapt videos to such dynamically varying network environments, see “ISO/IEC 14496-2:1999/FDAM4, “Information technology—coding of audio/visual objects, Part 2: Visual.” An overview of this amendment to the MPEG-4 standard is described by Li, “Overview of Fine Granularity Scalability in MPEG-4 Video Standard,” IEEE Trans. on Circuits and Systems for Video Technology, Vol. 11, No.3, pp. 301-317, March 2001.

An MPEG-4 FGS encoder generates two bitstreams: one is a base layer, and the other includes one or more enhancement layers. The purpose and importance of the two bitstreams are different. The base layer provides a basic decoded video. The base layer must be correctly decoded before the enhancement layer can be used. Therefore, the base layer must be strongly protected. The enhancement layer can be used to improve the quality of the basic video.

FGS coding is a radical departure from traditional scalable encoding. With traditional scalable encoding, the content is encoded into a base layer bitstream and possibly several enhancement layers, where the granularity is only as fine as the number of enhancement layers that are formed. The resulting rate-distortion curve resembles a step-like function.

In contrast, FGS encoding provides an enhancement layer bitstream that is continually scalable. The enhancement layer is generated by first subtracting frames of the base layer bitstream from corresponding frames of the input video. This yields an FGS residual signal in the spatial domain. A discrete cosine transform (DCT) encoding is then applied to the residual signal, and the DCT coefficients are encoded by a bit-plane coding scheme. Bit-plane encoding can generate multiple sub-layers for the enhancement layer bitstream. Hereinafter, the sub-layers are also referred to as enhancement layers.

FGS effort has focused on the following areas: improving coding efficiency, see Kalluri, “Single-Loop Motion-Compensated based Fine-Granular Scalability (MC-FGS),” MPEG2001/M6831, July 2001, and Wu et al., “A Framework for Efficient Fine Granularity Scalable Video Coding,” IEEE Trans. on Circuits and System for Video Technology, Vol. 11, No. 3, pp. 332-344, March 2001; truncating the enhancement layers to minimize quality variation between adjacent frames, see Zhang et al., “Constant Quality Constrained Rate Allocation for FGS Video Coded Bitstreams,” Visual Communications and Image Processing 2002, Proceedings of SPIE, Vol. 4671, pp. 817-827, 2000, Cheong et al., “FGS coding scheme with arbitrary water ring scan order,” ISO/IEC JTC1/SC29/WG11, MPEG 2001/M7442, July 2001, and Lim et al., “Macroblock reordering for FGS,” ISO/IEC JTC1/SC29/WG11, MPEG 2000/M5759, March 2000; and modifying the FGS coding structure to add time scalability, see Van der Schaar et al., “A Hybrid Temporal-SNR Fine Granular Scalability for Internet Video,” IEEE Trans. on Circuits and System for Video Technology, Vol. 11, No. 3, pp. 318-331, March 2001, and Yan et al., “Macroblock-based Progressive Fine Granularity Spatial calability (mb-PFGSS),” ISO/IEC JTC1/SC29/WG11, MPEG2001/M7112, March 2001.

An advantage of the FGS, compared to traditional scalable coding schemes, is its error resiliency. Losses or corruptions in one or more frames in the decoded enhancement layers do not propagate to following frames. Following frames are always first decoded from the base layer before the enhancement layers are applied.

In addition, the quality of the reconstructed video is proportional to the number of bits that are decoded. Therefore, FGS provides continuous rate-control of the streaming video because the enhancement layers can be truncated at any point to achieve a target bit-rate of the network bandwidth or other restrictions.

However, the MPEG-4 standard does not specify how the rate-allocation or how the bit-truncation of the enhancement-layer should be done. It only specifies how the truncated bit stream should be decoded.

When viewing a decoded video, humans perceive a decoded video with a constant, relatively moderate quality as being “better” than a decoded video where the quality varies between adjacent frames so that some frames have a high quality while others have a low quality. Therefore, the truncation should also minimize temporal variations in quality between adjacent frames.

One simple truncation method truncation evenly allocates the available bandwidth to the enhancement layer for each frame, see Van der Schaar et al., “A Hybrid Temporal-SNR Fine Granular Scalability for Internet Video,” IEEE Trans. on Circuits and System for Video Technology, Vol. 11, No. 3, pp. 318-331, March 2001. With that method, the same number of bits are transmitted over the network for each frame in the enhancement layer. However, if the complexity of the video varies between the adjacent frames, then the quality of the decoded video also varies perceptibly over time.

In order to solve this problem, a “nearest feather line” method can be used, see Zhao et al., “A Content-based Selective Enhancement Layer Erasing Algorithm for FGS Streaming Using Nearest Feather Line Method,” Visual Communications and Image Processing, Proceedings of SPIE, Vol. 4671, pp. 242-249, 2002. That method evaluates the “importance” of each frame, and assigns bits to the enhancement-layers according to the importance.

Another method uses optimal rate allocation to truncate the enhancement-layer bit-stream, see Zhang et al., “Constant Quality Constrained Rate Allocation for FGS Video Coded Bitstreams,” Visual Communications and Image Processing, Proceedings of SPIE, Vol. 4671, pp. 817-827, 2002, and Zhao et al., “MPEG-4 FGS Video Streaming with Constant-Quality Rate Control and Differentiated Forwarding”, Visual Communications and Image Processing, Proceedings of SPIE, Vol. 4671, 2003. Their methods generate sets of rate-distortion (R-D) points during the encoding of the enhancement-layers. Then, interpolation is used to estimate an R-D curve for each frame of the enhancement-layer. The R-D curve is used to determine the number of bits that should be truncated. Those methods can minimize the variation of quality between adjacent frames.

However, all of the prior art methods ignore the spatial variation of quality within a frame.

As shown in FIG. 1, the reason that the prior art methods cannot minimize variations in quality within frames is that the MPEG-4 FGS standard uses a normal scan order to encode the enhancement-layer bit-stream. The normal scan order encodes macroblocks, e.g., 1−N, of a frame 100 sequentially beginning with the macroblock 1 in upper-left corner, and ending with the macroblock N in the bottom-right corner of the frame. As a result, as shown in FIG. 2, only part of the decode frame 200 is enhanced when the last transmitted bit-plane layer is truncated, and part 201 of the decoded frame is not enhanced. Thus, the quality in the entire frame will not be uniform.

A water-ring scan order, together with selective enhancement can be used to process an area of interest within a frame, see Cheong et al., “FGS coding scheme with arbitrary water ring scan order,” ISO/IEC JTC1/SC29/WG11, MPEG 2001/m7442, July 2001. The bit-plane in the area of interested is selective enhanced and can be transmitted earlier than others. However, there are three problems with that method. First, the decoder needs to be modified to decode the water-ring scanned enhancement layer. Second, for most videos of natural scenes, it is difficult to define the area of interest. Third, a scene may include multiple areas of interest.

Another method uses a different scanning order of the macroblocks, see Lim et al., “Macroblock reordering for FGS,” ISO/IEC JTC1/SC29/WG11, MPEG 2000/m5759, March 2000. That method is based on the premise that macroblocks with large quantization-scale values in the base layer, have correspondingly high residual coefficients in the enhancement layer. Thus, the reordering sequence of the macroblocks for the enhancement layer uses two parameters from the base layer, the quantization scale value, and the number of DCT coefficients.

The enhancement-layer macroblock, whose corresponding base-layer macroblock has a larger quantization value and a large number of DCT coefficients, is encoded first. However, that method also requires a modification of the decoder, and it does not solve the varying spatial quality in the frame when the bit-plane is truncated.

Therefore, there is a need for a system an method that substantially maintains a constant spatial quality within frames when an enhancement layer of an FGS streaming video is truncated, without having to modify the decoder.

### SUMMARY OF THE INVENTION

A method for transcoding a video. First, a video is encoded into a base layer and one or multiple enhancement layers. Next, the last transmitted enhancement layer is partially decoded if an available bit-rate will truncate the last enhancement layer. A number of bits in the partially decoded last enhancement layer is reduced to match the available bit-rate, and the reduced last enhancement layer is then reencoded and transmitted at a reduced bit-rate.

### BRIEF DESCRIPTION OF THE DRAWINGS

FIG. 1 is a block diagram of a prior art sequential scan order for encoding enhancement layers of a video;

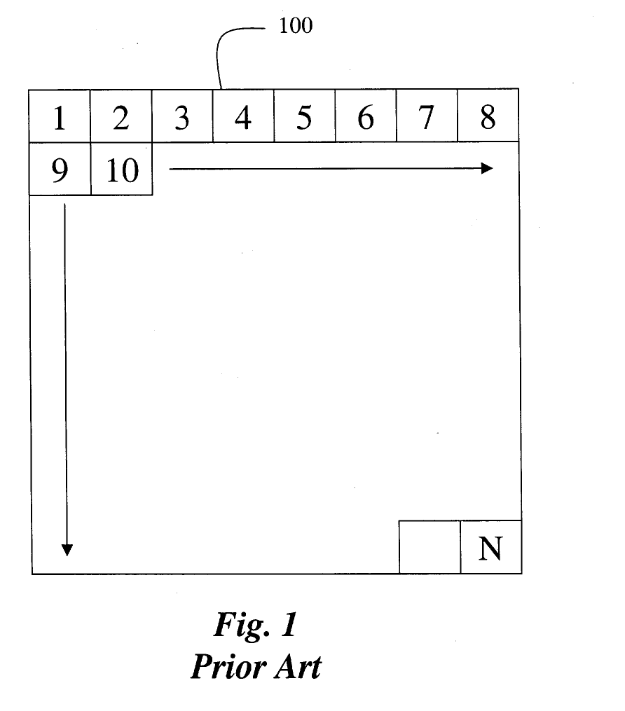

FIG. 2 is a block diagram of a partially enhanced decoded frame due to enhancement layer truncation;

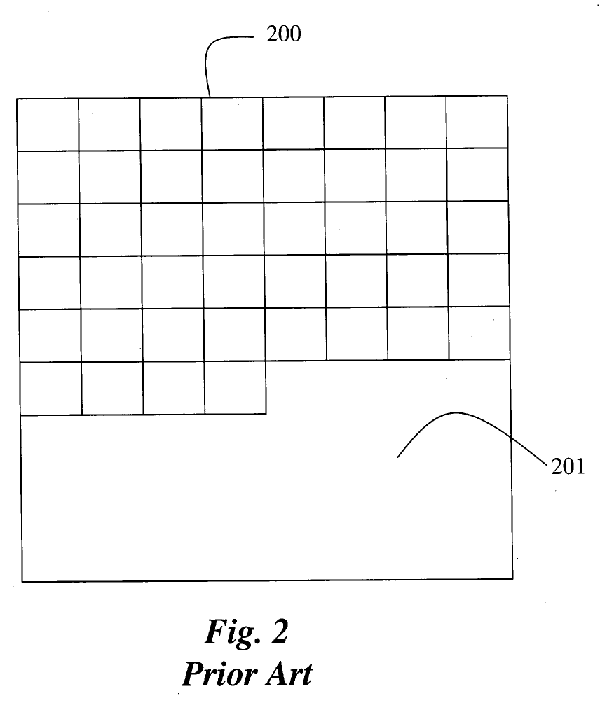

FIG. 3 is a block diagram of an FGS video encoder according to the invention;

FIG. 4 is a search trellis for reducing bits according to the invention;

FIG. 5 is a graph of a PSNR gain achieved by the invention.

### DETAILED DESCRIPTION OF THE PREFERRED EMBODIMENT

Our invention transcodes a fine-granular-scalability (FGS) video bitstream to enable a decoder to reconstruct frames with uniform spatial quality from an encoded base layer and one or more enhancement layers when network bandwidth is reduced. By uniform spatial quality, we mean that the quality is constant within each frame of the video.

Obviously, if the last decoded bit-plane of an enhancement layer reconstructs the entire frame, then the quality of the entire frame is enhanced uniformly. However, from time to time, the bit-rate of the channel over which the bitstreams are transmitted is less than required. Therefore, one or more enhancement layers (Bit-planes) are erased entirely, and sometimes an enhancement layer is truncated if the channel cannot transmit the entire enhancement layer. We call the truncated enhancement layer the last transmitted layer. Depending on where the last layer is truncated, the frame-to-frame spatial variation in quality can vary.

Therefore, we transcode the last transmitted enhancement layer so that each transcoded block of the last transmitted enhancement layer has a reduced number of bits after transcoding, but the reduced number of bits still encode the entire frame. By transcoding, we mean that the entire enhancement layer is partially decoded, down to the DCT coefficients. An inverse DCT is not performed.

The number of bits in the partially decoded layer is reduced, as described below, to meet bandwidth requirements. The reduced bit-rate enhancement layer is then reencoded. As a result, the decoder can reconstruct entire frames with a uniform spatial quality, even if the bit-rate of the channel is reduced.

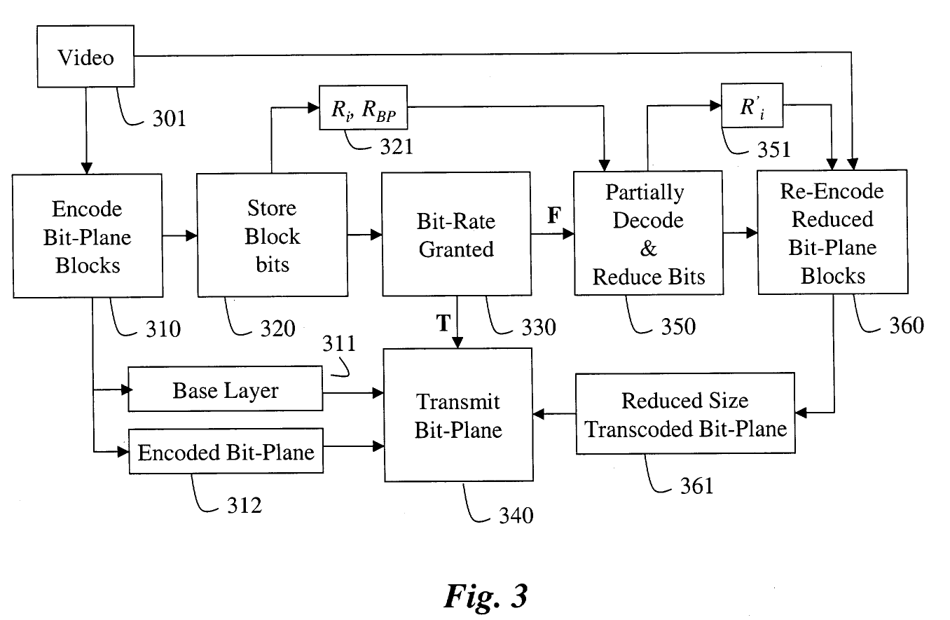

As shown in FIG. 3, our encoder and method 300 operates as follows. Blocks of each frame of an input video 301 are first encoded 310 as described in the MPEG-4 FGS standard to produce a base layer 311 and one or more enhancement layers including bit-planes 312.

The number of bits generated Rᵢ 321 for each block of each output bit-plane 312 is stored 320 in a memory, where i=0, 1, . . . , N−1, and N is the number of blocks in the bit-plane. The total number of bit in the bit-plane for all blocks in a frame is stored as R_{BP}.

Next, determine 330 whether the requested bit-rate necessary to transmit the FGS encoded video stream is granted, and if true, then transmit 340 the current bit-plane.

If false, partially decoded the last enhancement layer that would otherwise be truncated, and reduce the number of bits in each block according to:

$${R}_{i}^{′} = {R}_{i} - \frac{{R}_{i}}{{\sum }_{i = 1}^{N} {R}_{i}} \times ( {R}_{BP} - {R}_{Budget} ) ,$$

where Rᵢ is the number of bits used to encode 310 a block i, R′ᵢ is the number of bits required to re-encode 360 the block at a lower bit-rate R_{budgt}. The above equation indicates the over-shot bit budget (R_{BP}−R_{budget}) is allocated to each re-encoded block according to the contribution of the original bits of the entire frame.

Then, re-encode 360 each block of the last transmitted video bit-plane 312 to meet the requirement of the reduced number of bits R′ᵢ, and transmit 340 the reduced-size bit-plane 361.

There are several ways to reduce the bit-plane size. One simple way is as follows. Each enhancement layer block has 64 bits, either “0” or “1”, corresponding to the residual errors of DC coefficient for the highest AC frequencies. The encoding procedure with new bit budget means some of the “1” applied to enhance the high frequency DCT coefficients need to be dropped or erased. The reduction step 360 erases “1” values that enhance the high frequency DCT coefficients until the reduced bit-budget is met.

Rate-Distortion Optimization

With the above bit-rate reduction, we erase the “1” bits that corresponds to the highest AC frequencies in the DCT domain. However, that scheme is not optimized from a point of view of the rate-distortion (R-D). For example, two coefficients, “8” and “15” to be encoded in an enhancement layer block are represented by “1000” and “1111” in binary form. The most significant bitplane (MSB) for the first enhancement layer contains two “1.”

If only the MSB “1” bit corresponding to the “15” is transmitted, then the overall distortion is 113, in terms of a sum of square difference (SSD). If only the MSB “1” bit corresponding to the “8” is transmitted, then the overall distortion is 225 in terms of SSD. On the other hand, to erase the “1” bit related to “15” generates fewer bits to encode the MSB compared with erasing the “1” bit related to “8”. Therefore, there needs to be an optimal way to determine which bits to erase.

The bit-rate reduction problem can be generalized to select some “1” bits from the original block so that the re-encoded bit-stream meets both a restricted bit-budget and an optimal quality or minimal distortion.

Joint rate-distortion optimization can be used to solve this problem. For one block, we can minimize a cost function J(λ)=D(Rᵢ)+λRᵢ, where Rᵢ is the number of bits used to encode the current block, D(Rᵢ) is the distortion corresponded to the rate Rᵢ, and λ is an empirical parameter specified according to the quantization parameter of the base layer block.

As stated above, the bits associated with the DCT coefficient in a higher enhancement layer should be taken into consideration when determining the distortion that results when erasing a “1” bit in the current bit-plane,

In one enhancement layer block, there are 64 bits in one bit-plane. And each bit can be transmitted or erased. Yet the combination of the available erasure pattern is exponential to the number of “1” in the current block.

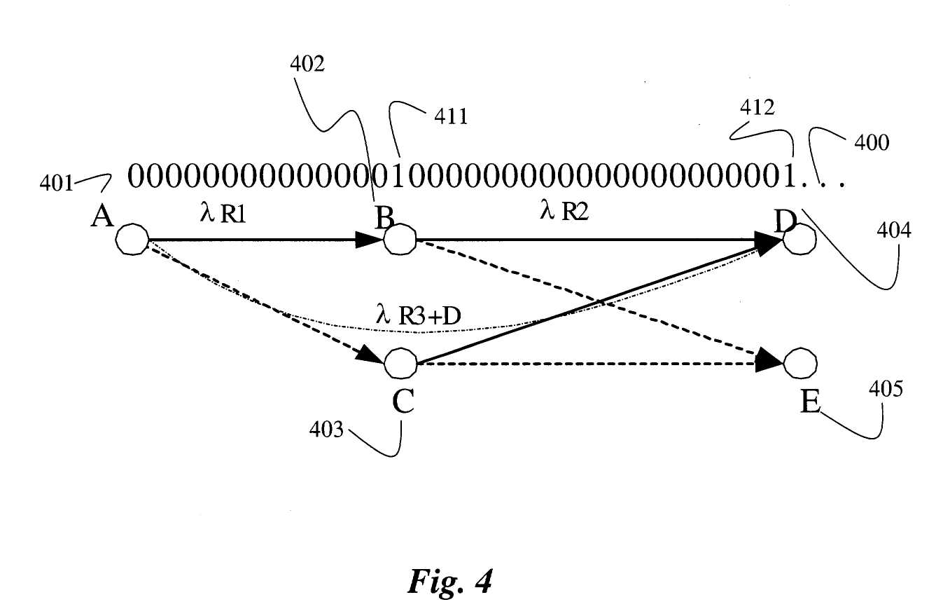

We can process the block by searching a trellis search as shown in FIG. 4, where A 401 indicates the start of the bit-plane 400. When the search reaches the 1^{st} “1” bit 411 in the bit plane 400, there're two ways to deal with it, either keep it as “1,” or it modify it to be a “0.” Thus, two states are generated, namely, “B” 402 and “C” 403. For route “A-B”, the cost function can be calculated as J=λRᵢ, where Rᵢ is the length of the code word necessary to describe the bit string so far. For route “A-C,” no cost function is yet available.

When the search reaches the 2^{nd} “1” bit 412 in the bit plane, there are four routes, namely, “BD”, “CD”, “BE”, “CE”. State “E” 405 indicates that this “1” is modified to “0”, and state “D” 404 indicates the “1” is retained. For the two routes entering the state “D”, one route is discarded, according to the value of the cost function λ(R₁+R₂), which corresponds to the route ABD, and λR₃+D corresponds to the route ACD, where R₃ is the length of the code word to describe the string of “ACD,” and D is the distortion incurred by changing the “1” in position “B” to “0.” The above procedure continues until the end of the block, or the bit-budget for the block is met to generate a local optimal route.

Effect of the Invention

To validate the effectiveness of our invention, we encoded the standard “Akiyo” video sequence, using a common-intermediate-format (CIF). The base-layer is encoded with a quantization parameter of Q=31 for both the I frames and P frames. There is no B frame in the sequence. For the enhancement layer, the total available bandwidth for the enhancement layers is 576 kb/s.

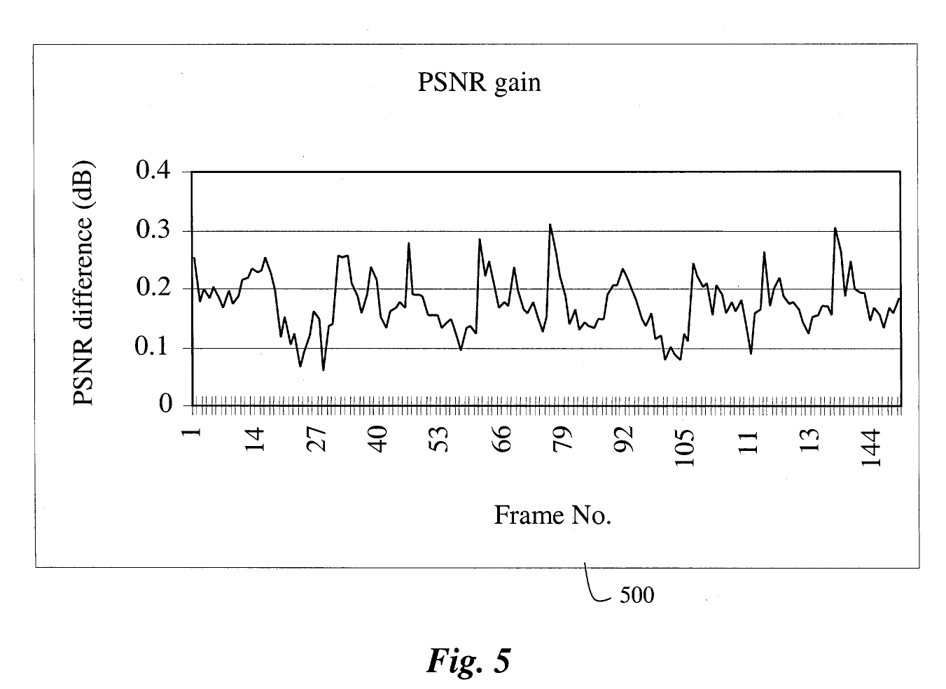

FIG. 5 shows the PSNR gain 500 of our method, when compared with the prior art “even truncation” method. For the entire video sequence, our invention obtains an average PSNR gain of 0.17 dB. We use the variance of the mean square error (MSE) of luminance component of each macroblock to measure the intra-frame quality variation. Our method also reduces the intra-frame quality variation by 26 percent.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for transcoding a video, comprising:
encoding a video into a base layer and at least one enhancement layer;
partially decoding a last enhancement layer to be transmitted if an available bit-rate will truncate the last enhancement layer;
reducing a number of bits in the partially decoded last enhancement layer to match the available bit-rate; and
reencoding the reduced last enhancement layer.

2. The method of claim 1 wherein the reduction is performed according to
$${R}_{i}^{′} = {R}_{i} - \frac{{R}_{i}}{{\sum }_{i = 1}^{N} {R}_{i}} \times ( {R}_{BP} - {R}_{Budget} ) ,$$
where Rᵢ is a number of bits used to encode each block I in a frame of the last enhancement layer, R′ᵢ is a number of bits required to reencode the block at the available bit-rate R_{budget}, and B_{BP} is a total number of bits used to encode the frame.

3. The method of claim 1 wherein the reduction erases “1” values that enhance high frequency DCT coefficients in each block until the available bit-rate is met.

4. The method of claim 1 further comprising:
evaluating a cost function to determine which “1” bits to erase.

5. The method of claim 4 wherein the cost function is J(λ)=D(Rᵢ)+λRᵢ, where Rᵢ is a number of bits used to encode a current block, D(Rᵢ) is a distortion corresponded to a bit-rate Rᵢ, and λ is an empirical parameter specified according to a quantization parameter of a block of the base layer.

6. The method of claim 4 further comprising:
searching a trellis while evaluating the cost function.
